(19) United States
(12) Patent Application Publication
(10) Pub. No.: US 2026/0176807 A1
(43) Pub. Date: Jun. 25, 2026

(54) DOSING APPARATUS

(71) Applicant: Herbert Saier GmbH, Gundelfingen (DE)

(72) Inventor: Michael SAIER, Freiburg/Kappel (DE)

(21) Appl. No.: 19/268,060

(22) Filed: Jul. 14, 2025

(30) Foreign Application Priority Data
Jul. 18, 2024 (DE) 10 2024 120 420.6

(51) Int. Cl. D06F 39/02; D06F 33/37; F16K 11/056

(52) U.S. Cl. CPC D06F 39/022; D06F 33/37; F16K 11/056

(57) ABSTRACT

A metering device for supplying a plurality of target apparatuses with one or more media, including a distributor having a plurality of inlets and one outlet, which includes two discs that are rotatable relative to one another and in particular are tensioned towards one another. The discs switch different communication paths between one of the inlets, in each case, and the outlet, in different rotational positions. A controller operates a drive of the distributor for bringing about a rotation of the discs relative to one another. A motor-driven ball valve is operated by the controller and has an inlet and at least two outlets. Each outlet of the ball valve is connected to a target apparatus. The outlet of the distributor is connected to the inlet of the ball valve via a fluid-conducting portion which can be acted on by a pump that is operated by the controller.

The invention relates to a metering device according to claim 1.

The applicant has been developing and manufacturing metering devices for metering and conveying media to different target apparatuses for decades.

In recent times, the applicant has developed what are known as distributor which comprise two discs that are rotatable relative to one another. The distributor can comprise a plurality of inlets and an outlet. Thus, a target apparatus, e.g. a washing machine, can be supplied a plurality of different media successively, in a metered manner. Such a distributor is described for example in WO 2013/075692 A1 by the applicant.

The applicant has also developed a method in which each time after a medium has been supplied rinsing of the fluid-conducting portions in the distributor with a rinsing agent, preferably with water, takes place.

The metering device by the applicant, described in the patent application to which reference is made, a plurality of target apparatuses can also be charged with media. In this respect, reference is made to FIG. 22 of WO 2013/075692 A1, which comprises a first distributor arrangement comprising a plurality of inlets and one outlet and a second distributor, comprising one inlet and a plurality of outlets, arranged in series therewith.

Proceeding from the described prior art, the object of the invention is that of specifying a metering device which can also be used in particular use situations, e.g. if a large height difference is to be overcome between the metering device and the target apparatus.

The invention achieves this object by the features of claim 1.

The principle of the invention consists substantially in specifying a metering device which comprises a distributor and a motor-driven ball valve. The ball valve comprises one inlet and a plurality of outlets. Typically, ball valves comprise two outlets or three outlets.

The invention thus allows for recourse to conventional, commercially available components.

A ball valve within the meaning of the invention comprises in particular a valve body, which is configured to be substantially spherical or comprises spherical surface-like portions, and which can be rotated about an axis of rotation by the motor drive of the ball valve. The drive can be operated by the controller. In different rotational positions of the valve body, the ball valve can switch different communication paths and selectively connect the inlet of the ball valve with an outlet of the plurality of outlets.

The ball valve provided according to the invention is in particular configured to be pressure-resistant. This is in particular an inherent property of a ball valve. The ball valve comprises a valve body which is substantially spherical and which is arranged in a housing that surrounds the valve body. The ball valve can provide a rotational position of the valve body, in which the valve body seals an outlet of the ball valve with respect to the inlet of the ball valve, in a pressure-resistant manner.

The ball valve is also configured to seal an outlet of the ball valve with respect to every other outlet of the ball valve. The sealing takes place in a pressure-resistant manner.

The metering device according to the invention can for example be arranged and installed in a basement room of a building, and one or more of the target apparatuses can be arranged e.g. in higher positions, e.g. in upper floors of the building. There may therefore be very large height differences between the metering device and the target apparatus. The volumes of liquid contained in the fluid-conducting portions between the metering device and the target apparatuses located in the upper floors can cause a high hydrostatic line pressure due to the large hydrostatic head. According to the invention, said line pressure is collected by the ball valve. The valve holds the hydrostatic line pressure remote from the pump and from the distributor.

The ball valve can protect the distributor, which is arranged upstream of the ball valve, and also the pump, which is likewise arranged upstream of the ball valve, from said high line pressures.

The distributor comprises two discs which are rotatable relative to one another and which are in particular tensioned towards one another. The distributor in particular comprises a tensioning device. This allows in particular for setting of the clamping force of the two discs relative to one another, as described for example in the patent application by the applicant mentioned at the outset, in particular in order to achieve the required tightness between the output side of the input disc and the input side of the output disc. The setting of the clamping force allows the two discs to move smoothly relative to one another.

Without the provision, given according to the invention, of a ball valve downstream of the distributor, a high line pressure existing in the lines could disrupt the distributor and/or the pump and cause leakages or backflows there, and e.g. also overcome the clamping force of the two discs against one another. Thus, leaks may unintentionally result, or undesired communication paths between the target apparatus and the inlets of the distributor, and thus possibly also the containers in which the different media are arranged, may be established. This can be reliably prevented according to the invention. In particular, according to the invention any return flow of media and rinsing agent is prevented.

The metering device according to the invention is connected on the input side to at least two containers in which at least one medium and one rinsing agent, in particular water, are arranged. The rinsing agent reservoir, e.g. a water reservoir, can be connected to a domestic water connection via a pipe divider.

According to the invention, the metering device can be connected on the input side to a plurality of containers, in which a plurality of different media are arranged.

Owing to the arrangement of a distributor, the metering device according to the invention in particular allows for a very large number of different containers comprising different media, e.g. seven media, to be connected on the input side of the metering device.

The invention also includes the case when the distributor is configured in a cascade-like manner and e.g. comprises two distributors which are connected in series. In this way, the number of containers, comprising different media, to be connected to the metering device on the input side can be increased.

The distributor can comprise an input disc which comprises a plurality of inlets, e.g. three or seven inlets, and one outlet. The input disc can comprise an output side which is in contact with an input side of an output disc. The output disc of the distributor comprises an opening of a through-channel on its input side, which channel leads to an outlet on the output side of the output disc. The two discs can consist of ceramic.

The discs are in particular tensioned towards one another, e.g. by a tensioning device which generates e.g. a screw or spring tension.

The distributor comprises a drive, in particular an electric motor, which can be operated by a controller of the metering device.

The controller can operate the drive of the distributor and also the drive of the ball valve, after receiving the requirement command from the target apparatus, and switch the desired communication paths between one of the inlets of the distributor and the outlet of the distributor, and between the inlet of the ball valve and a selected outlet of the ball valve. In this way, the desired communication path between a selected medium and a selected target apparatus is provided.

After the metering device has switched the corresponding communication paths, it can operate a pump. The pump acts on a fluid-conducting portion which is arranged between the outlet of the distributor and the inlet of the ball valve.

The invention relates in particular to a metering device which is configured for supplying a small number of target apparatuses, e.g. two to three apparatuses, with a large number of different media, e.g. with seven different media and a rinsing medium.

The ball valve comprises e.g. two outlets or three outlets, and is accordingly connected to two target apparatuses or three target apparatuses.

The invention also includes the case when the ball valve comprises more than three outlets.

In order to avoid repetitions, reference is made to the following prior art documents which are from the applicant and which all disclose metering devices: DE 10 2011 108 396 A1, DE 10 2011 119 021 A1, DE 10 2011 122 921 A1, DE 10 2012 012 913 A1, DE 10 2014 002 560 A1, DE 10 2014 010 126 A1, DE 10 2015 107 105 A1, DE 10 2015 107 976 A1, DE 10 2016 102 829 A1, DE 10 2017 103 168 B3, DE 10 2017 114 665 A1, DE 10 2017 114 767 A1, DE 10 2918 113 644 A1, DE 10 2018 122 651 A1, DE 10 2020 107 555 A1, DE 10 2020 107 558 A1, DE 10 2022 125 425 A1 and DE 10 2023 123 774 A1.

In order to avoid repetitions, the content of these intellectual property applications is hereby incorporated into the content of the present patent application, also in particular for the purpose, if required, of incorporating features from these documents into the content of the present application, if required also into the claims of the present application.

Embodiments of the metering device of the present patent application can be combined with any features of the metering devices of the above-mentioned prior art documents, also of the applicant's document mentioned at the outset. All of these combinations are included by the invention.

According to an advantageous embodiment of the invention, the target apparatuses are each configured as washing machines. This allows for central control of a plurality of washing machines with a single metering device.

According to an advantageous embodiment of the invention, the ball valve comprises a substantially spherical valve body which is rotatable about an axis of rotation. This allows for recourse to commercially available ball valves.

According to an advantageous embodiment of the invention, the valve body comprises at least one through-channel. This can be configured e.g. in the manner of a 90-degree bend, in particular curved. This allows for recourse to commercially available ball valves. The valve body can also comprise a plurality of through-channels.

According to an advantageous embodiment of the invention, in a first rotational position the valve body connects the inlet of the ball valve to a first outlet of the ball valve, and in a second rotational position it connects the inlet of the ball valve to a second outlet of the ball valve. This allows for recourse to commercially available ball valves.

According to a further advantageous embodiment of the invention, in a third rotational position the valve body blocks the outlet of the ball valve with respect to the inlet of the ball valve in a pressure-resistant manner. This ensures that the distributor, which is arranged upstream of the ball valve, is not subjected a high line pressure, which occurs downstream of the ball valve.

Further advantageously, in the third rotational position the valve body can simultaneously also block an outlet of the ball valve, in a pressure-resistant manner, with respect to any other outlet of the ball valve.

According to an advantageous embodiment of the invention, the ball valve comprises one inlet and two outlets, or one inlet and three outlets. This allows for recourse to commercially available ball valves.

According to a further advantageous embodiment of the invention, one of the inlets of the distributor is connected to a rinsing agent reservoir, e.g. a water reservoir. This allows for rinsing of the fluid-conducting portions each time after conveying of a medium.

Further advantages of the invention emerge from the dependent claims (not cited) and the following description of the embodiments shown in the drawings, in which:

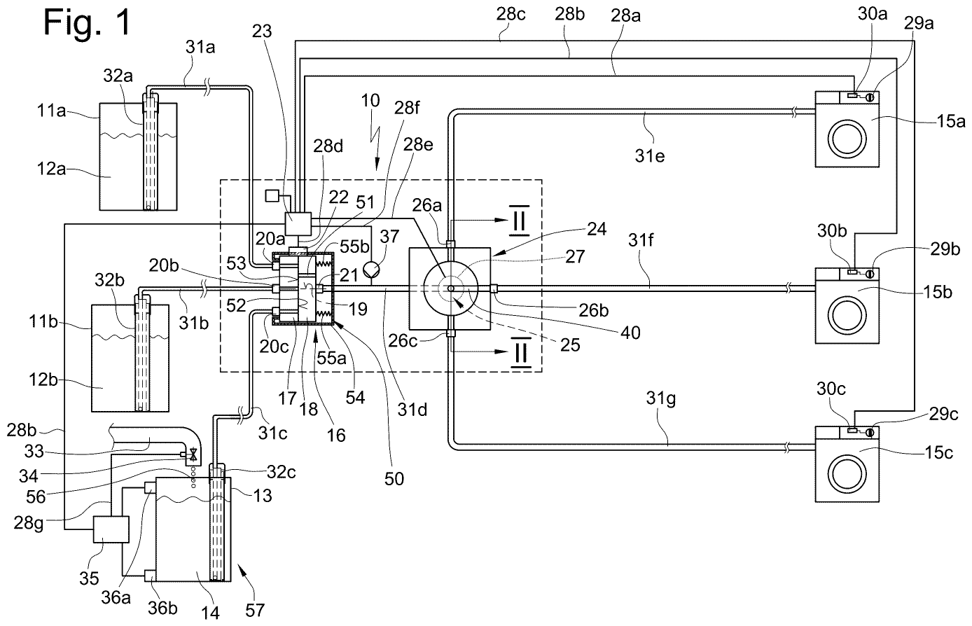

FIG. 1 is a partially sectional, schematic, block diagram-like view of a first embodiment of a metering device according to the invention, which comprises a distributor, to which two containers and a rinsing agent reservoir are connected on the input side, and which comprises a ball valve having one inlet and three outlets, to which three washing machines are connected on the output side,

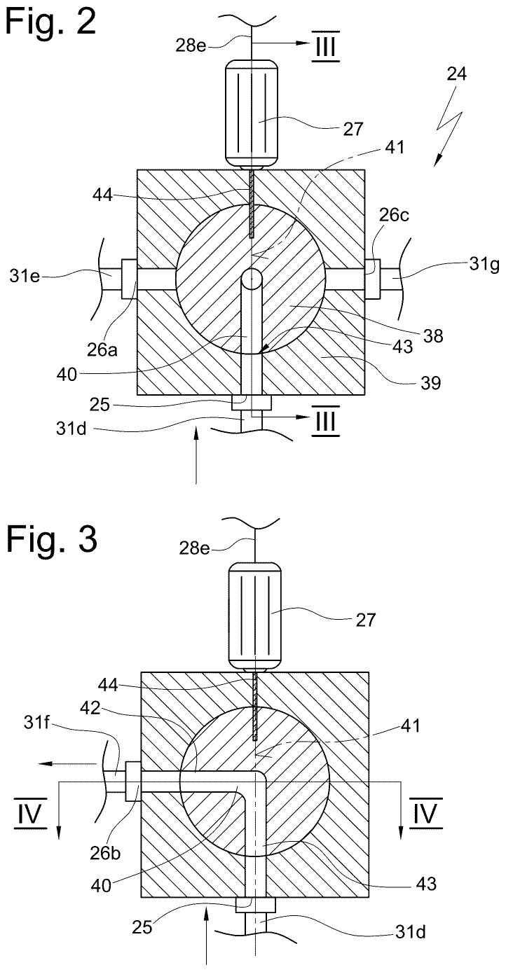

FIG. 2 is a partially sectional, cut-off, schematic view, approximately along the sectional line II-II in FIG. 1, of an embodiment of a ball valve and its drive,

FIG. 3 is a partially sectional, schematic view of the ball valve of FIG. 2, approximately along the sectional line III-III in FIG. 2,

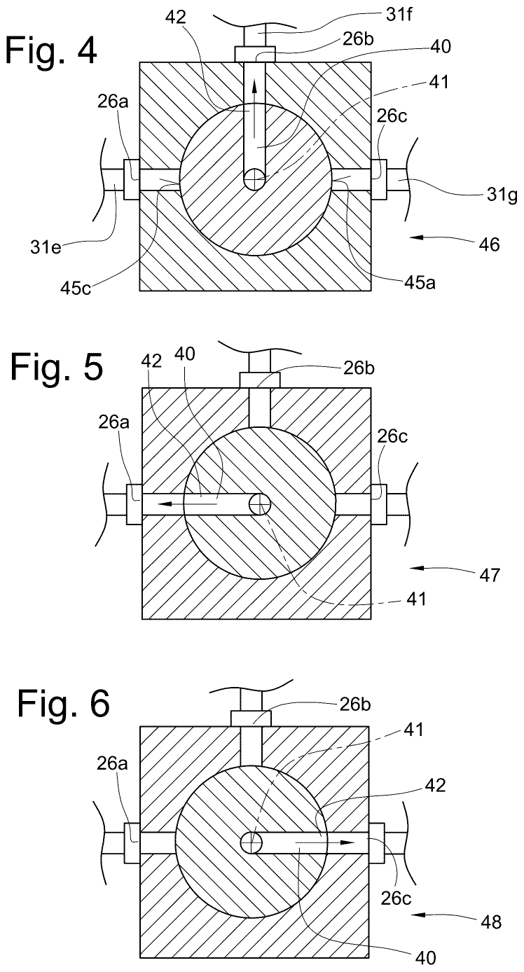

FIG. 4 is a partially sectional, schematic view of the ball valve of FIG. 3, approximately along the sectional line IV-IV in FIG. 3, with a valve body located in a first rotational position, corresponding to the illustrations of FIGS. 1 to 3,

FIG. 5 shows the ball valve of FIG. 4 comprising a valve body located in a changed rotational position,

FIG. 6 shows the ball valve of FIG. 4 comprising valve body located in a further changed rotational position, and

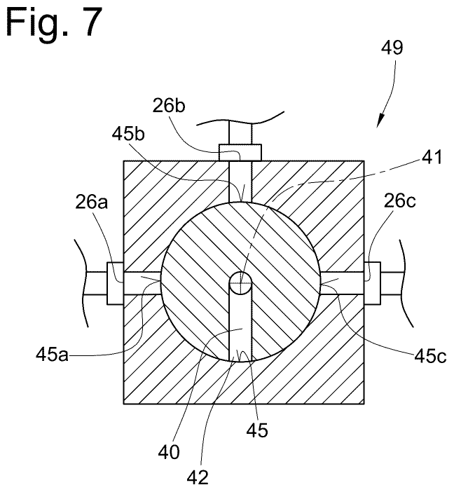

FIG. 7 shows the ball valve of FIG. 4 comprising a valve body located in a further changed rotational position.

The embodiments of the invention are explained on the basis of the following description of the drawings:

Embodiments of the invention are explained by way of example in the following description of the figures, with reference to the drawings. In this case, for the sake of clarity—even if relating to different embodiments-identical or comparable parts or elements or regions are denoted by the same reference signs, sometimes with the addition of lower-case letters.

Features which are described only with respect to one embodiment can also be provided, in the context of the invention, in any other embodiment of the invention. Embodiments amended in this way are—even if not shown in the drawings—also included by the invention.

All the disclosed features are essential to the invention individually. The contents of the disclosures of the associated priority documents (copy of the prior application) and of the cited documents and the described devices of the prior art are hereby incorporated in their entirety into the disclosure of the application, also for the purpose of incorporating individual or multiple features of said documents into one or more claims of the present application.

An embodiment of the metering device according to the invention is denoted in its entirety, in the drawings, by the reference sign 10.

The metering device 10 according to the invention comprises a distributor 16 and a ball valve 24.

On the input side, two containers 11a, 11b are connected to the metering device 10, in each of which containers a medium 12a, 12b is arranged. The number of containers 11a, 11b and the number of media 12a, 12b can be selected freely by a person skilled in the art.

Furthermore, a rinsing agent reservoir 13 is connected to the metering device 10 on the input side, in which reservoir water 14 is located. The metering device 10 can convey the different media 12a, 12b or water 14 in a metered manner to a selected target apparatus 15a, 15b, 15c.

The distributor 16 comprises an input disc 17 and an output disc 18 that is rotatable relative thereto about an axis of rotation 19.

Three inlets 20a, 20b, 20c are arranged on the distributor 16, on the input side. An outlet 21 is arranged on the output disc 18. The outlet 21 of the distributor 16 is connected to an inlet 25 (not visible in FIG. 1) of a ball valve 24 arranged on the underside of said ball valve 24. The ball valve 24 comprises three outlets 26a, 26b, 26c.

A removal of the media 12a, 12b or the water 14 takes place with the aid of suction lances 32a, 32b, 32c via fluid lines 31a, 31b, 31c which connect the respective container 11a, 11b, 13 to the metering device 10. The ball valve 24 is connected on the output side to the target apparatuses 15a, 15b, 15c via fluid lines 31e, 31f, 31g.

In the embodiment of FIG. 1, the target apparatuses 15a, 15b, 15c are all formed by washing machines.

A programme selector switch 29a, 29b, 29c is arranged on each of the target apparatuses 15a, 15b, 15c, which switch is connected to a control unit 30a, 30b, 30c of the respective target apparatus 15a, 15b, 15c.

The distributor 16 comprises a drive 22 which can displace the two discs 17, 18 in different relative rotational peripheral positions and in this way switch communication paths between one of the inlets 20a, 20b, 20c and the outlet 21. The drive 22 can be operated by the controller 23 of the metering device 10. The output disc 18 of the distributor 16 comprises a through-channel 51. This is, if required, brought into communicative connection with one of the inlets 20a, 20b, 20c following a relative rotation of the two discs 17, 18.

The two discs 17, 18 are tensioned towards one another, such that the output side 52 of the input disc 17 contacts the input side 53 of the output disc 18 with a predetermined clamping force. The clamping force is set such that a tightness of the two surfaces 52, 53 relative to one another is achieved, but the surfaces still move smoothly and the two discs 17, 18 can rotate past one another as a result of a relative rotational movement.

In order to set the clamping pressure, a tensioning device 50 can be provided, which can e.g. comprise a housing 54 which encloses the two discs 17, 18. Furthermore, the tensioning device 50 can comprise springs 55a, 55b which can be supported on the housing 54 in order to preload the two discs 17, 18 against one another.

The distributor 16 can in particular correspond to the distributor disclosed in WO 2013/075692 A1. The invention also includes the case when a tensioning device 50 comprises a direct screw-tensioning of the two discs 17, 18 against one another, and e.g. does without a separate housing 54.

The ball valve 24 will be explained in the following with referenced to FIG. 2-7:

The ball valve 24 comprises a valve body 38 which is configured substantially in the manner of a ball. The valve body 38 is arranged on a housing 39 and is rotatable, by a drive 27, about an axis of rotation 41.

The valve body 38 comprises a through-channel 40 which, according to FIG. 3, is configured in the manner of a 90° bend.

A drive 27 is associated with the ball valve 24, which drive can also be operated by the controller 23 of the metering device 10. The drive 27 comprises an output shaft 44 which is connected to the valve body 38 for conjoint rotation. The output shaft 44 has an axis of rotation that coincides with the axis of rotation 41 of the valve body 38.

The through-channel 40 comprises two ends 42 and 43.

According to FIG. 1-7 the ball valve 24 comprises an inlet 25 which, as emerges most clearly from FIGS. 2 and 3 in overview, is arranged directly on the geometric axis of rotation 41 or is crossed by the axis of rotation 41 of the valve body 38.

In all the different rotational positions of the valve body 38, which are explained below, the through-channel 40 is arranged having its input-side end 43 always opposite the inlet 25.

The output-side end 42 of the through-channel 40 of the valve body 38 can, in different rotational positions of the valve body 38, be brought in each case into communicative connection with one of the three outlets 26a, 26b, 26c.

FIG. 2-4 show a rotational position of the valve body 38, in which the output-side end 42 of the through-channel 40 is communicatively connected to the outlet 26b.

This position of the valve body 38 is referred to in the present patent application as the first rotational position 46 of the valve body 38.

In said first rotational position of the valve body 38, according to FIG. 1 conveying of medium 12a, 12b or of water 14 to the target apparatus 15b can be performed.

FIG. 5 shows a second rotational position 47 of the valve body 38. Compared with the position of FIG. 4 the valve body 38 is rotated by 90° anticlockwise about the axis of rotation 41. Now, the output-side end 42 of the through-channel 40 is communicatively connected to the first outlet 26a.

In said second rotational position 47 of the valve body 38, as can be seen from FIG. 1, conveying of media 12a, 12b or water 14 to the target apparatus 15a can take place.

In a third rotational position 48 of the valve body 38 according to FIG. 6 the output-side end 42 of the through-channel 40 is communicatively connected to the third outlet 26c of the ball valve 24.

In said rotational position of the valve body 38, conveying of medium 12a, 12b or water 14 towards the third target apparatus 15c can take place.

FIG. 7 finally shows a further rotational position 49 of the valve body which is referred to as the blocking position. In the blocking position, all three outlets 26a, 26b, 26c of the ball valve 24 are sealed in a pressure-resistant manner against one another and optionally the inlet 25 by corresponding sealing surfaces 45a, 45b, 45c of the valve body 38 and with the aid of a sealing surface 45d on the housing 39.

The output-side end 42 of the through-channel 40 is closed by the sealing surface portion 45 in the rotational position 49 according to FIG. 7.

It is noted that a pressure-resistant sealing of the fluid lines 31e, 31f, 31g arranged on the output side of the ball valve 24, relative to the pump 37 and relative to the distributor 16, also takes place in the remaining rotational positions of the valve body 38. For example, FIG. 4 makes it clear that a sealing surface 45a on the valve body 38 seals the output 26c of the ball valve 24 and a sealing surface 45c seals the output 26a of the ball valve 24.

The particular feature of a ball valve 24 within the meaning of a pressure-resistant sealing results from the fact that the valve body 38 cannot veer and, in the case of pressure which arises on one side of the valve body 38, a displacement of the valve body 38 in the direction of the action of pressure is not permitted.

The metering device 10 comprises numerous signal and control lines, which are denoted by the reference sign 28, in particular with lower-case letters added.

Thus, for example, the control unit 30a of the target apparatus 15a is connected to the controller 23 of the metering device 10 via a signal line 28a. The control device3 30b of the target apparatus 15b is connected to the controller 23 via a control line 28b, and the target apparatus 15c is connected to the controller 23 via a signal line 28c.

The controller 23 is connected to the drive 22 of the distributor 16 via a signal line 28d.

The controller 23 is also likewise connected to the drive 27 of the ball valve 24 via a signal line 28b.

The controller 23 is moreover connected to the pump 37, e.g. a hose pump, via a signal line 28f.

FIG. 1 shows that the rinsing agent reservoir 13 is connected to a domestic water connection 33 via a pipe divider 57.

The control unit 35 of the pipe divider 57 is connected to an openable and closable blocking switch 34 of the domestic water connection 33 via a signal line 28g. The control unit 35 of the pipe divider 57 can also be connected to the controller 23 of the metering device 10 via a signal line 28h.

The controller 23 can for example comprise two or more level sensors 36a, 36b.

If the supply of water 14 in the rinsing agent reservoir 13 runs low, this can be detected by a level sensor 36b of the control unit 35. The control unit 35 thereupon operates the blocking switch 34 and allows water 14 into the rinsing agent reservoir 13 via a freefall route denoted by reference sign 56. As soon as the upper level sensor 36a has identified a sufficient filling level, it informs the control unit 35 of this. This then actuates the blocking switch 34 and stops a water supply.

The freefall route 56 reliably prevents contamination of the domestic water network.

The mode of operation of the metering device 10 according to the invention can be explained as follows:

After a requirement command for a certain volume of a certain medium 12a has been received from a target apparatus 15a, the controller 23 initiates a metering process.

For this purpose, it triggers an operation of the drive 22 of the distributor 16 and of the drive 27 of the ball valve 24, and a switching of the communication paths between the container 11a with the required medium (e.g. 12a) and the target apparatus 15a.

Then, the controller 23 can operate the pump 37 and remove the required volume of medium 12a from the container 11a and convey it to the target apparatus 15a.

Subsequently, the distributor 16 can bring the through-channel 51 into communicative connection with the rinsing agent reservoir 13 and the line paths can be rinsed with water as a result of renewed operation of the pump 37.

Thereafter, the target apparatus 15a can request another medium, e.g. the medium 12b, or the same medium 12a, or another target apparatus 15b, 15c can request a medium 12a. Thereupon, the controller 23 again triggers a switching of the corresponding communication paths.

If no further medium 12a or rinsing agent 14 is conveyed, the controller 23 can trigger the valve body 38 of the ball valve 27 to be displaced into a blocking position according to FIG. 7, such that any line pressures downstream of the ball valve 24 can be held by the pump 37 and by the distributor 16.

In the case of a valve body 38 located in the blocking position 49, according to FIG. 7, there is no communicative connection between the inlet 25 of the ball valve 24 and the outlets 26a, 26b, 26c of the ball valve.

FIG. 7 shows that a pressure-resistant sealing of each outlet with respect to the inlet 25 of the ball valve 24, but simultaneously also with respect to every other outlet, is achieved in every blocking position.

The ball valve 24 is configured to be pressure-resistant. Any line pressure arising downstream of the ball valve 24 is kept away from the ball valve 24 by the pump 37 and also by the distributor 16.

The target apparatuses 15a, 15b, 15c can be located in a part of a building which is positioned far above the metering device 10. There may be several metres, possibly several tens of metres, of height difference between the metering device 10 and the target apparatus 15a, 15b, 15c.

Typically, a ball valve 24 that is to be used according to the invention has a pressure resistance of up to several bar, in particular of up to 10 bar.

Both the valve body 38 and the housing 39 consist in particular of a chemically resistant plastics material. Both the housing 39 and the valve body 38 are in particular configured as plastics injection-moulded parts.

1-10. (canceled)

11. A metering device for supplying a plurality of target apparatuses with one or more media, comprising: a distributor having a plurality of inlets and one outlet, the distributor comprising two discs that are rotatable relative to one another, wherein the discs provide in different rotational positions different communication paths between a respective one of the inlets and the outlet; a controller for controlling a drive of the distributor for rotating the discs relative to one another; and a motor-driven ball valve operable by the controller and having an inlet and at least two outlets, wherein each outlet of the ball valve is connected to a target apparatus, wherein the outlet of the distributor is connected to the inlet of the ball valve via a portion of a fluid line that is acted on by a pump operated by the controller.

12. The metering device according to claim 11, wherein each of the target apparatuses is a washing machine.

13. The metering device according to claim 11, wherein the ball valve comprises a substantially spherical valve body which is rotatable about an axis of rotation.

14. The metering device according to claim 13, wherein the valve body comprises at least one through-channel.

15. The metering device according to claim 13, wherein, the valve body in a first rotational position connects the inlet of the ball valve to a first outlet of the ball valve and in a second rotational position connects the inlet of the ball valve to a second outlet of the ball valve.

16. The metering device according to claim 13, wherein the valve body, in a third rotational position, blocks at least one outlet of the ball valve with respect to the inlet of the ball valve, in a pressure-resistant manner.

17. The metering device according to claim 13, wherein the valve body, in one rotational position, blocks the outlet of the ball valve with respect to at least one other outlet of the ball valve, in a pressure-resistant manner.

18. The metering device according to claim 11, wherein the ball valve comprises one inlet and two outlets.

19. The metering device according to claim 11, wherein the ball valve comprises one inlet and three outlets.

20. The metering device according to claim 11, wherein one of the inlets of the distributor is connected to a rinsing agent reservoir.

21. The metering device according to claim 11, wherein the two discs are biased towards one another.
